(19) United States
(12) Patent Application Publication
(10) Pub. No.: US 2006/0038365 A1
(43) Pub. Date: Feb. 23, 2006

(54) Recreational board

(76) Inventor: Graeme Scott Halfacree, Clayfield (AU)

Correspondence Address: Kolisch Hartwell, 200 Pacific Building, 520 SW Yamhill Street, Portland, OR, 97204, US

(21) Appl. No.: 10/533,554

(22) PCT Filed: Oct. 28, 2003
(86) PCT No.: PCT/AU03/01423

§ 371 Date: Apr. 28, 2005

(30) Foreign Application Priority Data
Oct. 28, 2002 (AU) 2002952288

(51) Int. Cl. B62B 13/00; B62B 15/00

(52) U.S. Cl. 280/14.21

(57) ABSTRACT

A recreational board (10) travelling across a medium, said recreational board (10) comprising: a board (10) having a top surface (20) and a bottom surface (30); said top surface (20) supporting a user positioned on said recreational board (10); and said bottom surface (30) contacting the medium on which the board (10) travels; wherein the bottom surface (30) includes a plurality of grooves (32) that radiate from a central zone (31) on said bottom surface (30) to adjacent a side edge of the bottom surface (30).

### FIELD OF THE INVENTION

This invention relates to a recreational board. In particular, the invention relates to a recreational board for use on snow and therefore will be described in this context. However, it is envisaged that the recreational board may be used on other surfaces such as water, sand, rock, grass and air.

### BACKGROUND OF THE INVENTION

In recent years, snowboarding has become a very popular winter sport. Most snowboards are made from substantially elongate, flexible fibreglass panel. The front and rear of the snowboard are turned upwardly with an intermediate portion being substantially planar. Straight edges of the intermediate portion are used to turn the snowboard whilst the upturned edges of the front and rear prevent the snowboard digging into the snow.

To ride a snowboard down a piste, it is important that a user constantly rocks their feet backward and forward so that a user does not dig the edge of the snowboard sharply into the snow, known as “catching an edge”. “Catching an edge” causes the user to be flung down the piste often causing injury. Unfortunately, “catching an edge” is easily achieved when the user is a beginner.

To slow or stop the snowboard when riding a snowboard down a piste involves turning the snowboard. A beginner, or even an experienced user, will therefore find it difficult to stop or slow down when on a narrow piste due to sharp turns being required. Further, as often many turns are required to slow a snowboard, the “chances of catching” an edge are greatly increased.

### OBJECT OF THE INVENTION

It is an object of the invention to overcome or alleviate one or more of the above disadvantages or provide the consumer with a useful or commercial choice.

### SUMMARY OF THE INVENTION

In one form, although not necessarily the only or broadest form, the invention resides in a recreational board for travelling across a medium, said recreational board comprising:
a board having a top surface and a bottom surface
said top surface supporting a user positioned on said recreational board; and
said bottom surface contacting the medium on which the board travels;
wherein the bottom surface includes a plurality of grooves that radiate from a central zone on said bottom surface to adjacent a side edge of the bottom surface.

The board may be shaped so that a front portion of the board is narrower than a rear portion of the board. Preferably, the board tapers from the rear portion of the board to front portion of the board.

The board may be constructed from any suitable material such as fibreglass or polycarbonate resin.

The top surface of the board may contain bindings to attach one or more feet to the board. Preferably there are two bindings. The rear binding may be inclined so that a front of the foot is positioned lower than a heel of the foot.

Preferably, the bottom surface is convex. Preferably, the front portion and rear portion are turned upwardly.

The grooves may extend forwardly from the central portion to the sides. Preferably, the grooves extend from the central portion to both sides of the board.

The rear portion may also include a brake to slow or stop the board. Preferably, the brake includes at least one channel that engages with the medium on which the board is travelling. Normally, there are a plurality of channels. The brake may be engaged by inclining the board rearwardly.

The recreational board may be a snowboard, sand board or water board, grass, rock and air board.

### BRIEF DESCRIPTION OF THE DRAWINGS

Embodiments of the invention, by way of example only, will be described with reference to the accompanying drawings in which:

FIG. 1 is a side perspective view of a snowboard according to a first embodiment of the invention.

FIG. 2 is a top view of the snowboard shown in FIG. 1.

FIG. 3 is a rear perspective view of the snowboard shown in FIG. 1.

FIG. 4 is a front perspective view of the snowboard shown in FIG. 1.

FIG. 5 is bottom view of the snowboard shown in FIG. 1.

FIG. 6 is another top view of the snowboard shown in FIG. 1.

FIG. 7 is a sectional view of the snowboard of FIG. 6.

FIG. 8 is a bottom view of a snowboard according to a second embodiment of the invention.

FIG. 9 is a side view of the snowboard of FIG. 8.

FIG. 10 is a sectional view of a snowboard of FIG. 8.

### DETAILED DESCRIPTION OF THE PREFFERED EMBODIMENT

Referring to the figures, a snowboard 10 is shown having a top surface 20 and a bottom surface 30. The snowboard also has a pointed front portion 40 and a curved rear portion 50. The snowboard 10 is manufactured from fibreglass and is substantially wedge shaped.

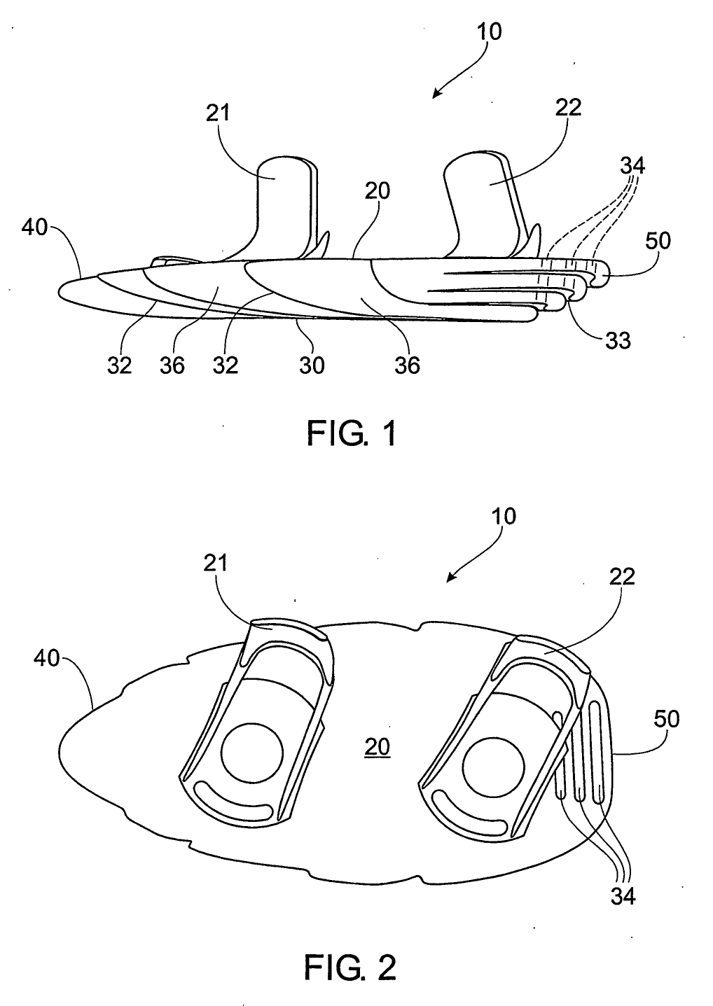

The top surface 20 of the snowboard is substantially flat. Two bindings 21 and 22 are fixed to the top of the snowboard in a conventional manner such as using adhesives and/or fasteners. It should be appreciated that different bindings may be used dependant upon the type of shoe used. For example, FIGS. 1 and 2 show bindings 21 and 22 for soft shoes. However, the bindings may be replaced with bindings that allow for the use of hard shoes.

The rear binding 22 is inclined so that a user's heel is higher than a front part of a users foot. This allows for greater control of movement of the snowboard 10 as well as providing greater comfort to a user when riding the snowboard 10.

The bottom surface 30 is substantially convex. The bottom surface 30 has a central portion 31 from which extend a series of grooves 32. Each of the grooves 32 extend forwardly from the central portion 31 to their respective sides of the snowboard 10.

Between each groove 32 is a land 36. A front part 36A of the land is relatively steep with a rear part 36B of the land 36 gradually tapering away to an adjacent groove 32 as shown in FIG. 7.

Channels 33 are located at the rear portion of the snowboard 10. The channels 33 are of a greater depth compared with the depth of the grooves 22. The channels 33 are provided to brake the snowboard to slow or stop the snowboard. Holes 34 are located within the channels 33 to prevent snow from building up within the channels 33.

In use, a user binds their feet to the snowboard 10 using respective bindings 21 and 22. The inclined position of the rear foot of a user assists a user in enabling the snowboard 10 to be swayed both from side to side and also be titled upwardly.

To steer the snowboard 10, a user leans their body weight to the left or right of the snowboard 10. This causes the front part 36A of each of the forward facing lands 36 located between the grooves 32 to engage with the snow to turn the snowboard 10. When travelling in a straight line, the lands 36 do not substantially engage the snow due to the bottom surface 30 being convex. No grooves 32 and hence no lands 36 are located on the central portion 31.

To stop or slow the snowboard 10, a user lifts their front foot and leans backwardly on their back foot to cause the board to be titled upwardly. This causes the channels 33 located in the rear portion 50 to plough into the snow thus braking the snowboard 10. Snow passes through the holes 34 within the channels 33 so that the channels 33 continue to brake the snowboard 10.

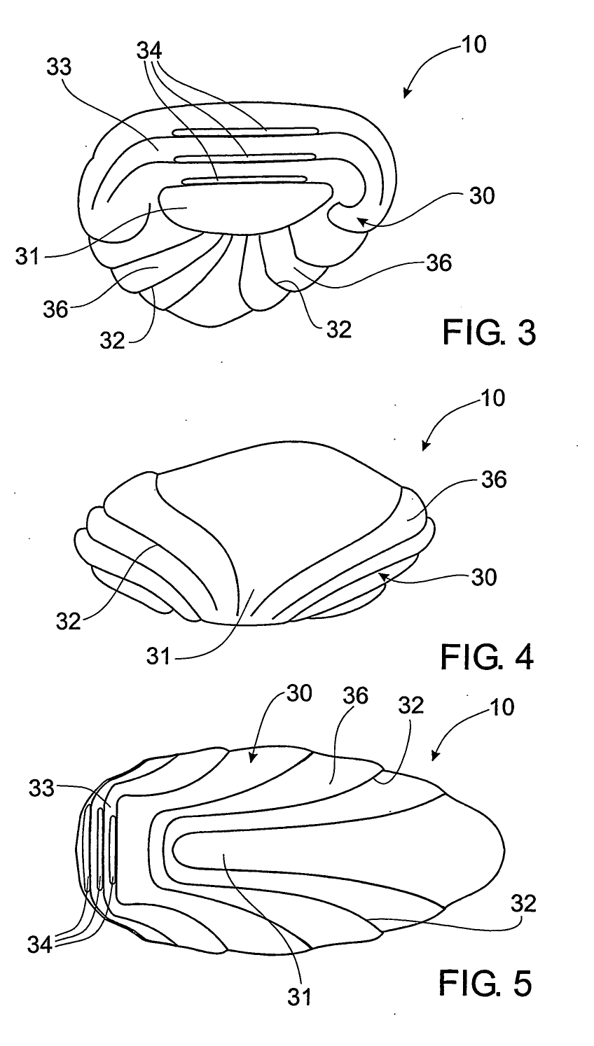

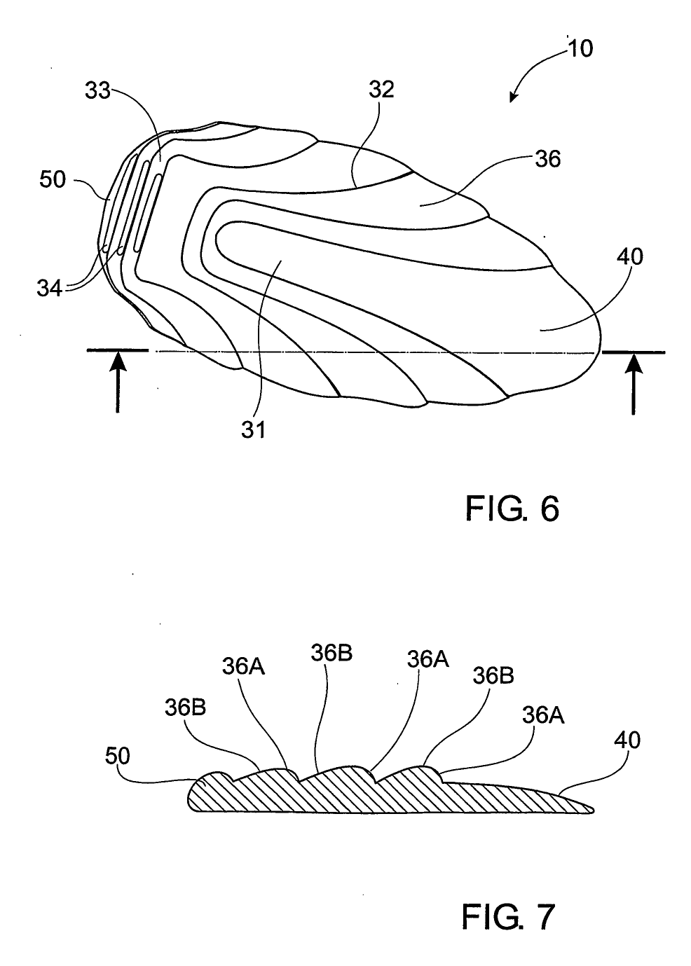

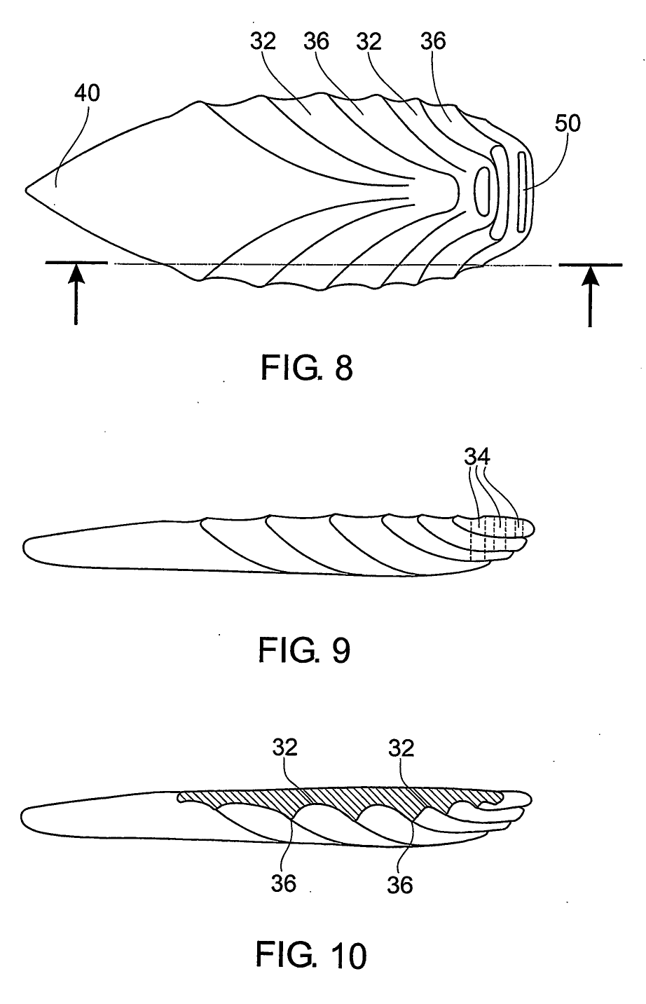

FIGS. 8 to 10 show another embodiment of the invention. In this embodiment the grooves 32 are wider whilst the lands 36 are narrower and sharper. The narrower and sharper lands 36 allow the snowboard to be more responsive than the snowboard described in FIG. 1 to FIG. 7. However, both snowboard uses the same principles to turn the snowboard.

The above snowboards 10 enables users to turn sharply, travel easily in a straight line and stop or slow the snowboard without turning.

It should be appreciated that various other changes and modifications may be made to the embodiment described without departing from the spirit or scope of the invention.

1. A recreational board for travelling across a medium, said recreational board comprising:
a board having a top surface and a bottom surface;
said top surface supporting a user positioned on said recreational board; and
said bottom surface contacting the medium on which the board travels;
the board being shaped so that a front portion of the board is narrower than a rear portion of the board;
wherein the bottom surface includes a plurality of grooves that extend forwardly from a central zone on said bottom surface to adjacent a side edge of the bottom surface.

2. The recreational board of claim 1 wherein the board tapers from the rear portion of the board to front portion of the board.

3. The recreational board of claim 1 wherein the top surface of the board contains bindings.

4. The recreational board of claim 3 wherein there are two bindings.

5. The recreational board of claim 4 where a rear binding is inclined with respect to the top surface of the board.

6. The recreational board of claim 1 wherein the bottom surface is convex.

7. The recreational board of claim 1 wherein the front portion and rear portion are turned upwardly.

8. The recreational board of claim 1 wherein the rear portion also includes a brake.

9. The recreational board of claim 8 wherein the brake includes at least one channel.

10. The recreational board of claim 9 wherein there are a plurality of channels.

11. The recreational board of claim 1 where the recreational board is a snowboard, sand board, water board or air board.
